(19) United States
(12) Patent Application Publication
(10) Pub. No.: US 2025/0024200 A1
(43) Pub. Date: Jan. 16, 2025

(54) LOUDSPEAKER BOX WITH FLOATING DISPLAY

(71) Applicant: Shenzhen ShengZhi Youpin Technology Co., Ltd, Shenzhen (CN)

(72) Inventor: Xiangjie LI, Shenzhen (CN)

(73) Assignee: Shenzhen ShengZhi Youpin Technology Co., Ltd, Shenzhen (CN)

(21) Appl. No.: 18/765,357

(22) Filed: Jul. 8, 2024

(30) Foreign Application Priority Data
Jul. 13, 2023 (CN) 2023218379267

(51) Int. Cl. H04R 5/02; G02B 30/56; G02F 1/13357; H04R 5/04

(52) U.S. Cl. CPC H04R 5/02; G02B 30/56; G02F 1/133615; H04R 5/04; H04R 2420/07; H04R 2499/11; H04R 2499/15

(57) ABSTRACT

Disclosed is a loudspeaker box with floating display including a housing, a first transparent plate arranged on front side of the housing, a second transparent plate arranged on rear side of the housing, a first speaker embedded in the first transparent plate, and a display module and a control circuit arranged in the housing. The display module includes a translucent liquid crystal panel arranged behind the first speaker and a backlight module matched with a back of the translucent liquid crystal panel at intervals. The display module of the invention displays lyrics and background through a translucent liquid crystal panel arranged behind the first speaker to create a display effect hidden behind the first transparent panel, and the translucent liquid crystal panel is matched with the backlight module at intervals, so that a display content of the translucent liquid crystal panel has a floating three-dimensional effect in naked eye vision.

### CROSS-REFERENCE TO RELATED APPLICATIONS

The application claims priority to Chinese patent application No. 2023218379267, filed on Jul. 13, 2023, the entire contents of which are incorporated herein by reference.

### TECHNICAL FIELD

The invention relates to the technical field of the loudspeaker box, in particular, to a loudspeaker box with floating display.

### BACKGROUND

In one type of product design in the prior art, a display unit is configured in a loudspeaker box to display lyrics or other information when playing music. According to common habits of users, the display interface of the display unit and the speaker of the loudspeaker box are generally located on the front side of the loudspeaker box, and the speaker of the loudspeaker box needs to consider the pursuit of sound quality more. Therefore, when the speakers and the display units coexist, the structural assembly of the loudspeaker box often becomes complicated, resulting in high cost, poor sound quality, large size and heavy weight.

In view of the above shortcomings of the prior art, it is necessary to propose new improvements to the prior art.

### SUMMARY

In view of the above shortcomings of the prior art, the invention provides a loudspeaker box with floating display with the following technical solutions.

A loudspeaker box with floating display includes a housing, a first transparent plate arranged on a front side of the housing, a second transparent plate arranged on a rear side of the housing, a first speaker embedded in the first transparent plate, and a display module and a control circuit arranged in the housing. The display module includes a translucent liquid crystal panel arranged behind the first speaker and a backlight module matched with a back of the translucent liquid crystal panel at intervals.

Optionally, the first transparent plate and the second transparent plate are any one of a touch panel, a glass, an acrylic, and a transparent PC.

The backlight module includes a light guide plate and a light-emitting circuit board; the light-emitting circuit board is arranged at an edge of one side of the light guide plate, and the light guide plate is illuminated from the edge by the light-emitting circuit board, so that the light guide plate forms a surface light source that emits light evenly.

In an improved technical solution, one or more loudspeaker box components are arranged in the housing, and the loudspeaker box component includes a loudspeaker box cavity and a second speaker arranged on the loudspeaker box cavity.

Further, one or more passive plates are arranged on the loudspeaker box cavity.

Optionally, one or more first speakers are arranged.

In an improved technical solution, a rechargeable battery is arranged in the housing.

In an improved technical solution, the control circuit is configured with an AI voice control module, and the AI voice control module includes a voice control chip and at least two sound pickup heads.

In an improved technical solution, a wireless audio signal receiving chip and an antenna are arranged in the control circuit, and the wireless audio signal receiving chip is any one of a U-segment chip, a 2.4G chip, a 5.8G chip and a Bluetooth chip.

Compared with the prior art, the utility model has the following beneficial effects:
(1) The sound quality is good, the assembly is easy, the cost is low and the weight is light.
(2) The display module displays lyrics and background through a translucent liquid crystal panel arranged behind the first speaker to create a display effect that is hidden behind the first transparent panel, and the translucent liquid crystal panel is matched with the backlight module at intervals, so that a display content of the translucent liquid crystal panel has a floating three-dimensional effect in the naked eye vision.
(3) The karaoke function can be expanded.

The invention is further described below with reference to the accompanying drawings and specific implementations of the specification.

### BRIEF DESCRIPTION OF DRAWINGS

FIG. 1 is a structure diagram of the invention.

FIG. 2 is an exploded structure diagram of the invention.

FIG. 3 is a structure diagram of a display module of the invention.

FIG. 4 is a structure diagram of a loudspeaker box component of the invention.

FIG. 5 is a structure diagram of an electrical structure of the invention.

FIG. 6 is a structure block diagram of the invention.

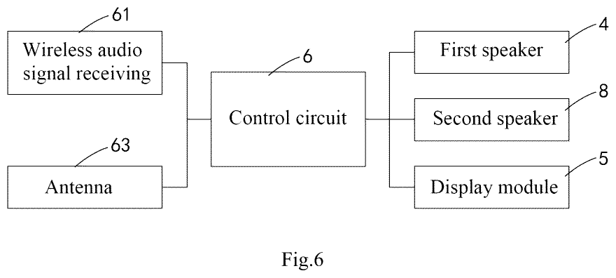

### DETAILED DESCRIPTION OF THE EMBODIMENTS

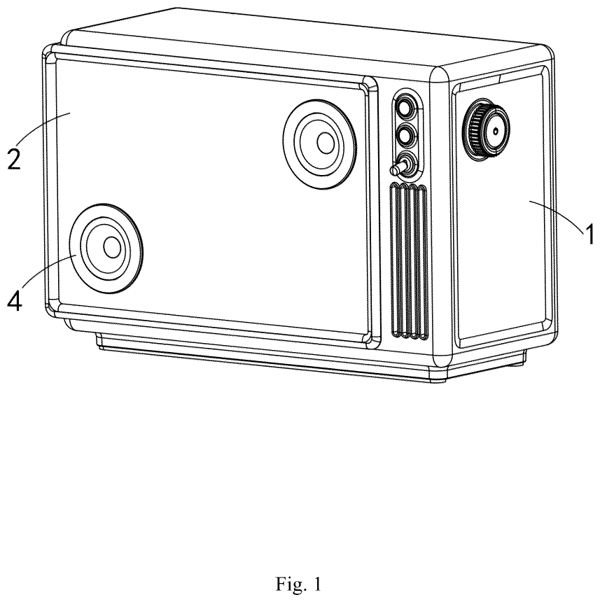

As shown in FIGS. 1 to 3, in an embodiment, a loudspeaker box with floating display of the invention includes a housing 1, a first transparent plate 2 arranged on a front side of the housing 1, a second transparent plate 3 arranged on a rear side of the housing 1, a first speaker 4 embedded in the first transparent plate 2, and a display module 5 and a control circuit 6 arranged in the housing 1. The display module 5 includes a translucent liquid crystal panel 51 arranged behind the first speaker 4 and a backlight module 52 matched with a back of the translucent liquid crystal panel 51 at intervals.

In the above embodiment, the structure of the loudspeaker box with floating display of the invention is more reasonable, and the display module 5 is placed behind the first speaker 4; therefore, the sound quality of the first speaker 4 is less affected, resulting in good sound quality, easy assembly, low cost, and light weight.

In the above embodiment, the display module 5 displays lyrics and background through a translucent liquid crystal panel 51 arranged behind the first speaker 4 to create a display effect that is hidden behind the first transparent panel 2, and the translucent liquid crystal panel 51 is matched with the backlight module 52 at intervals, so that a display content of the translucent liquid crystal panel 51 has a floating three-dimensional effect in the naked eye vision.

In the above embodiment, optionally, the first transparent plate 2 and the second transparent plate 3 are any one of a touch panel, a glass, an acrylic, and a transparent PC.

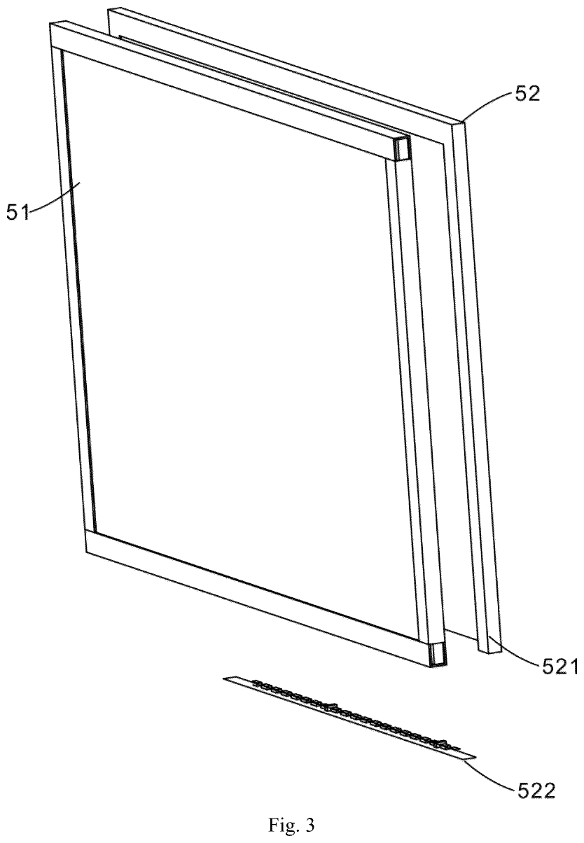

In the above embodiment, as shown in FIG. 3, the backlight module 52 includes a light guide plate 521 and a light-emitting circuit board 522; the light-emitting circuit board 522 is arranged at an edge of one side of the light guide plate 521, and the light guide plate 521 is illuminated from the edge by the light-emitting circuit board 522, so that the light guide plate 521 forms a surface light source that emits light evenly.

In the above embodiment, the circuit connection structure of the display module 5 and the control circuit 6 may be obtained according to the prior art, so the invention will not elaborate on it.

In addition, a rechargeable battery (not shown) may also be arranged in the housing 1 to increase the portability of the invention and make it a mobile portable device. Meanwhile, configuring a button switch and a charging interface on the housing 1 is an inherent conventional technical means, and thus the invention will not elaborate on it.

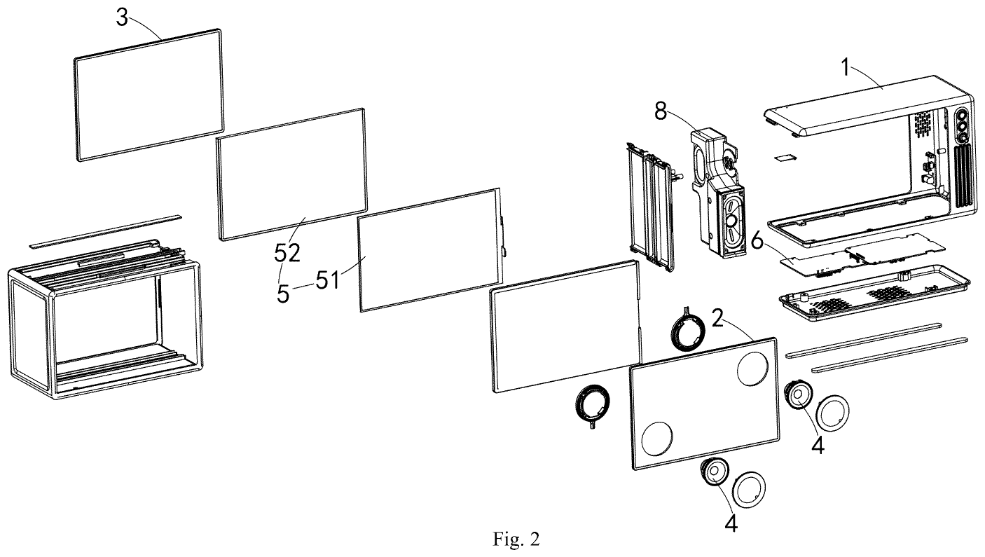

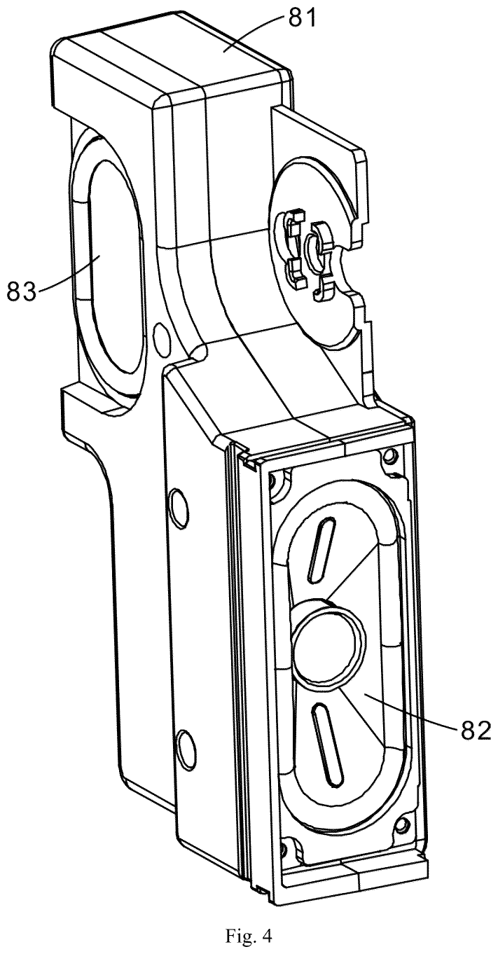

As shown in FIG. 2, in another preferred embodiment, one or more loudspeaker box components 8 are arranged in the housing 1. The loudspeaker box components 8 may be used to enhance the low-frequency performance of the loudspeaker box, thereby improving the sound quality. Specifically, as shown in FIG. 4, the loudspeaker box component 8 includes a loudspeaker box cavity 81 and a second speaker 82 arranged on the loudspeaker box cavity. Further, as shown in FIG. 4, one or more passive plates 83 are arranged on the loudspeaker box cavity 81.

Optionally, one or more first speakers 4 are arranged.

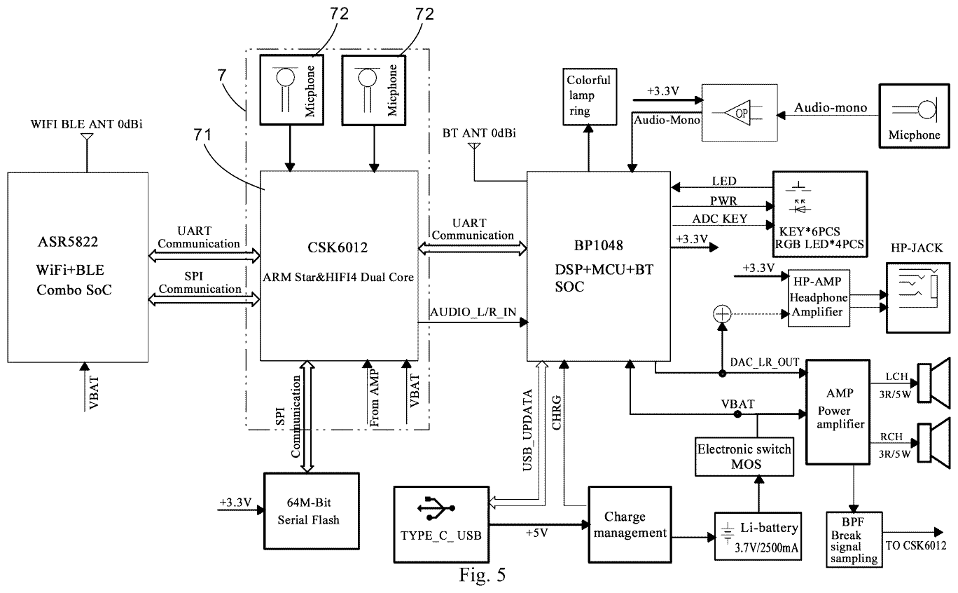

As shown in FIG. 5, the control circuit 6 is configured with an AI voice control module 7, and the AI voice control module includes a voice control chip 71 and at least two sound pickup heads 72. The AI voice control module 7 recognizes voice commands of a user through the sound pickup heads 72, thereby realizing the control in switches and the adjustment in settings for the system. In order to facilitate sound pickup, a through hole is provided on the housing 1 for the sound pickup heads 72 to be placed therein, which is not shown in the figure because of a conventional setting. As shown in FIG. 5, the AI voice control module 7 uses CSK6012 as the voice control chip.

As shown in FIG. 4, in another preferred embodiment, a wireless audio signal receiving chip 61 and an antenna 63 are arranged in the control circuit 6, and the wireless audio signal receiving chip 61 is any one of a U-segment chip, a 2.4G chip, a 5.8G chip and a Bluetooth chip, so that the invention may also be matched with a wireless microphone to expand the karaoke function. In the exemplary circuit: when the U-segment chip is used, the wireless audio signal receiving chip 61 is KT0656; wen the 2.4G chip is used, the wireless audio signal receiving chip 61 is Jerry AC7016; when a 5.8G chip is used, the wireless audio signal receiving chip 61 is Weifeng AW5808; when a Bluetooth chip is used, the wireless audio signal receiving chip 61 is Bluex AB5312. The above is only an exemplary selection of the wireless audio signal receiving chip 61, and the actual selection can be made according to known technical means.

For those skilled in the art, the protection scope of the invention is not limited to the details of the above exemplary embodiments. Without departing from the spirit or basic characteristics of the invention, all changes and implementations within the equivalent meaning and protection scope made by those skilled in the art based on the essentials of the invention shall be included in the invention.

What is claimed is:

1. A loudspeaker box with floating display, comprising a housing, a first transparent plate arranged on a front side of the housing, a second transparent plate arranged on a rear side of the housing, a first speaker embedded in the first transparent plate, and a display module and a control circuit arranged in the housing, wherein the display module comprises a translucent liquid crystal panel arranged behind the first speaker and a backlight module matched with a back of the translucent liquid crystal panel at intervals.

2. The loudspeaker box with floating display according to claim 1, wherein the first transparent plate and the second transparent plate are any one of a touch panel, a glass, an acrylic, and a transparent PC.

3. The loudspeaker box with floating display according to claim 1, wherein the backlight module comprises a light guide plate and a light-emitting circuit board; the light-emitting circuit board is arranged at an edge of one side of the light guide plate, and the light guide plate is illuminated from the edge by the light-emitting circuit board, so that the light guide plate forms a surface light source that emits light evenly.

4. The loudspeaker box with floating display according to claim 1, wherein one or more loudspeaker box components are arranged in the housing, and the loudspeaker box component comprises a loudspeaker box cavity and a second speaker arranged on the loudspeaker box cavity.

5. The loudspeaker box with floating display according to claim 4, wherein one or more passive plates are arranged on the loudspeaker box cavity.

6. The loudspeaker box with floating display according to claim 1, wherein one or more first speakers are arranged.

7. The loudspeaker box with floating display according to claim 1, wherein a rechargeable battery is arranged in the housing.

8. The loudspeaker box with floating display according to claim 1, wherein the control circuit is configured with an AI voice control module, and the AI voice control module comprises a voice control chip and at least two sound pickup heads.

9. The loudspeaker box with floating display according to claim 1, wherein a wireless audio signal receiving chip and an antenna are arranged in the control circuit, and the wireless audio signal receiving chip is any one of a U-segment chip, a 2.4G chip, a 5.8G chip and a Bluetooth chip.
